(19) United States
(12) Patent Application Publication
(10) Pub. No.: US 2008/0243285 A1
(43) Pub. Date: Oct. 2, 2008

(54) Method For Scheduling and Controlling of Jobs and a Management Information System

(75) Inventor: Thomas Reichhart, Aldenhoven (DE)

Correspondence Address: URSULA B. DAY, ESQ., 708 Third Avenue, SUITE 1501, NEW YORK, NY, 10017, US

(73) Assignee: Hiflex Software Gesmbh, Wien (AT)

(21) Appl. No.: 12/089,453

(22) PCT Filed: Oct. 6, 2005
(86) PCT No.: PCT/EP2005/010779

§ 371 Date: Apr. 7, 2008

(51) Int. Cl. G06Q 10/00; G06F 17/00

(52) U.S. Cl. 700/103

(57) ABSTRACT

A method for planning and control of jobs is disclosed, wherein work steps (10, 11-19) are organised for the jobs with cost centres of limited capacity based on logical connections of the work steps (10, 11-19), determining a temporal sequence for carrying out the work steps (10, 11-19) and on the predicted duration of the execution of the work steps (10, 11-19) at the cost centres, with generation of a representation of a sequence for execution of the work steps (10, 11-19) of the job for each job, based on the organisation and also, for each cost centre, a work job with each work step (10, 11-19) to be carried out and furthermore, a management information system for organization and control of jobs for the production of printed items (1) in a networked graphic production with an organizing module, by means of which the work steps (10, 11-19) of the jobs are organized at cost centres with limited capacity and for generation, for each job, of a representation of a sequence for execution of the work steps (10, 11-19) of the job and, for each cost centre, a work job with each work step (10, 11-19) to be carried out and comprising a control module by means of which the execution of the work steps (10, 11-19) may be controlled. According to the invention, the planning, calculation and presentation expense for non-bottleneck cost centres can be reduced without losing information crucial for the control wherein the work job is a to-do-list for the non-bottleneck cost centre. Within the organization for the work steps (10, 11-19) to be carried out, no sequence is determined nor are such non-bottleneck cost centres definable in the management information system.

The invention relates, on the one hand, to a method for scheduling and controlling jobs, wherein production steps of the jobs in cost centers with limited capacity are scheduled based on logical linking of the production steps, which determines a time sequence of the execution of the production steps, and based on the anticipated durations of executing the production steps are scheduled in the cost centers, wherein based on the scheduling, both an illustration of the sequence of execution of the production steps is generated for each job, and also a job order is generated for each cost center, which includes the respective production steps to be executed. The invention furthermore relates to a management information system for scheduling and controlling jobs for producing print products in a networked graphic production, comprising a scheduling module, by means of which production steps of the jobs can be scheduled in cost centers with limited capacity, an illustration of a sequence of execution of the production steps of the job can be generated for each job, and a job order comprising the production steps to be executed can be generated for each cost center, and wherein the management information system comprises a control module, by means of which the execution of the production steps can be controlled.

Such methods are generally referred to as methods for “production planning and control” (PPS), wherein the consideration of the available capacities of the cost centers and of the systems associated therewith is also expressed by the term “capacity scheduling” for scheduling, when planning time schedules, in order to avoid uneven loading, and in particular overloading cost centers. The allocation of production steps to available cost centers in consideration of timeliness logical links in the context of a job and limitations of the respective capacity of the cost center is referred to as “scheduling”. The ideal goal of scheduling is the reliable delivery of all jobs at minimal cost at the desired delivery date. “Continuous scheduling” as a generally known opposite term for capacity scheduling, by comparison designates a planning process without consideration of the available capacities, thus it is no scheduling in the classical sense. For a cost center, in which production steps are planned by means of continuous scheduling, the production steps are only compiled according to a type of “to-do list”, thus without preset start- or completion dates.

Scheduling is generally based on an also generally known method of network planning, by means of which, on the one hand, the logical contexts of a job are illustrated from the beginning to the end of the execution in a clear, demonstrative and meaningful manner. On the other hand, a time schedule can be developed, which comprises all production steps of a job, and a critical path and resource constraints, which can jeopardize keeping the end date can be identified. The description of the sequence of execution of the production steps of a job in a time schedule is the basis for controlling the execution of the job in the sense of a continuous project control and time schedule monitoring with reference to the particular production steps.

A production step or “event” is a defined work packet in the context of network planning, which is started at a certain point in time, and which is completed at a certain later point in time. It is the object of network planning to determine, when the respective production steps are performed in consideration, on the one hand, of the duration of the particular production steps, and, on the other hand, in consideration of their mutual dependencies. The depiction of the execution of a job is thus performed in a “network” by nodes and arrows connecting them. According to the “event node method”, in particular the “critical path method”, CPM, the production steps are represented by arrows and the respective start- and end dates are represented as “events” by nodes. According to the “process node method”, in particular the “metra potential method”, MPM the nodes, on the other hand, represent the production steps and the arrows represent their logical relationship.

A management information system (MIS) as described supra, which implements the scheduling and control methods as described supra, is generally known from the company of the applicant under the product designation “HIFLEX” (www.hiflex.de). A scheduling module of the known system is used for production optimization and for day- and shift related scheduling and control. Each production step has a respective cost center start date and a cost center end date in the known system. The scheduling module schedules between said dates on a minute to minute basis, and automatically computes a production schedule. An operator of the system can manually interfere with the determination of the production schedule, among other things supported by a graphic overview of the taken and available capacities of the particular cost centers, e.g. by allocating priorities, or by setting fixed dates. Bottleneck cost centers, critical paths and critical dates are emphasized in color on a screen in overview tables, diagrams and over the time axis in bar charts, so-called “Gantt charts”, and can thus be identified early on. In the known system, each production step for executing a job is planned and controlled in detail. During the execution of a job, the known system accesses the production schedule and facilitates an association of status reports, which are generated from manual entries at BDE terminals, and also generated from automatically executed production steps by the connected execution systems, preferably at the milestones defined in the scheduling module.

In the known system, according to the rules developed by the consortium, “International Cooperation for the Integration of Processes in Prepress, Press and Postpress” (“CIP4-consortium”, www.cip4.org), also those production steps are planned in detail, which do not actually require detailed execution planning. For example, in the area of preprint, the page and print format generation during the actual print, the exposure of a plate, and in the area of postpress, the binding, packaging and shipping of a finished print product, typically do not constitute a bottleneck. Also, the actual detailed schedule of subcontracted production steps, for which overcapacities exist in the market, does not have to be known when scheduling the execution of the job.

The CIP4 specification is based on the goal to standardize the communications between print shop, designer, advertising agency, customer for printed products and subcontractors of contractors in the context of a networked graphic production for all production alternatives and eventualities in a flexible manner and without restrictions. The “job definition format” (“JDF”) defined for this purpose and the “job messaging format” (“JMF”), as a subset of JDF, is based on the “extensible markup language” (“XML”), also a commonly known META language, developed by the “World Wide Web Consortium” (“W3C”, www.w3.org) for defining document types, and is intended according to the CIP4-consortium to be used as a standardized data format for describing processes and products, not only in all production areas of a networked print shop, in particular in sales, job costing, job processing, production planning and control; in the actual production in prepress, print, print post processing and shipping, in the cross sectional areas like materials- and warehouse management, financial payroll accounting, controlling, cost accounting, and quality assurance.

Through the vertical integration of data, on the one hand, of the production process, and on the other hand, of the financial areas, JDF is to facilitate a high level of transparency of all production processes, a standardized documentation of the relevant target- and actual data and a seamless production control in a comprehensible and integrated data structure. In particular, a job in JDF shall only be described once in one format, which is understood by all process partners, also in the external communications with end customers, and also with subcontractors and their executing systems in man-machine- and in machine-machine communications, over language- and platform boundaries.

Contrary to the philosophy of the CIP4-consortium and contrary to the concept of JDF based thereon, there are multiple restrictions in real operations of networked print shops, and there are specific differences with reference to the information, which is required and actually used by the particular process partners. Thus, in manual scheduling, thus without the known management information system, in a generally known manner, production steps in non-bottleneck cost centers are only considered in the form of minimum time spacings between the respectively proceeding and subsequent production steps. A cost center is designated as a “bottleneck”, which impedes the performance of the entire production process (here in a networked graphic production) by a capacity, which is not matched to the demand, e.g. time wise limited availability, or insufficient processing speed. The actual use of the respective non-bottleneck cost center, e.g. of a platesetter, is not considered in capacity planning.

Such a reduction of the planning, however, is not permitted in the CIP4-concepts, which makes sense, since the feedback from execution systems, which relate to production steps, which were not explicitly defined in the plan, could not be associated in a control based on said plan. For example, a JMF feedback “plate for job XYZ exposed” from a plate setter could not be associated, in case no separate production step on said executing system, in particular no production step “expose plate for job XYZ” was defined.

According to the CIP4-concepts, therefore, each production step, as long as it either requires a separate input parameter, or as long as it generates a separately relevant output in the subsequent process, has to be explicitly defined, and thus, has to be considered in planning, controlling and execution of a job. The non-avoidable planning, also of non-bottleneck resources, which are not detectable as such a priori by a CIP4 compatible management information system, not only significantly increases the computation effort, but thus also the cost through the hardware and the software requirements without generating economic value, compared to the manual planning and control, which was customary so far. Also the visual comprehension of capacity utilization diagrams is made unnecessarily difficult by the depiction of non-bottleneck resources, which is of no interest from a business point of view.

### OBJECT

It is the object of the invention to reduce the planning-computation and depiction complexity for non-bottleneck resources without losing information, which is essential for the control in the process.

### SOLUTION

Based on the known method, it is proposed according to the invention, that the job order for a non-bottleneck cost center is a to-do list, thus no sequence is determined in the context of the scheduling for the production steps to be executed. According to the known manual planning, which is reduced to the relevant cost centers, the capacity of the respective resource does not have to be considered in the scheduling according to the inventive method. The method according to the invention thus implements the following with reference to the non-bottleneck cost center, or with respect to the job: with reference to the production steps executed in a non-bottleneck cost center quasi a continuous scheduling, with the exception of production steps performed in non-bottleneck cost centers, start and completion dates are determined for all production steps in the context of the scheduling.

The method according to the invention thus facilitates under the conditions of the CIP4-concepts a significant reduction of the planning and computation effort for non-bottleneck cost centers. Besides using the respective cost centers, also production steps, which are “blacked out”, from a capacity point of view are defined sufficiently well in the method according to the invention, in order to facilitate the association of feedback reports to these cost centers during the execution control without restriction.

The method according to the invention furthermore facilitates processing status reports with reference to the execution of the production steps for controlling the respective subsequently scheduled production steps with significantly reduced planning, computation and depiction effort for non-bottleneck resources, relative to the known method. According to the method according to the invention, the sequence of the production steps, also in the non-bottleneck resources, is completely depicted in the MIS as a sole prerequisite of such processing of the status reports. Only the capacities associated with the non-bottleneck resources, whose consideration according to the known method generates planning-computation- and illustration complexity, without having any practically relevant use, are not being considered according to the method according to the invention.

Preferably, the anticipated duration of the execution of a production step in a non-bottleneck cost center is planned in the context of the scheduling as an intermediary time period between a logical predecessor of the production step and a logical successor of the production step.

The definition of “intermediary time periods” between the particular production steps is generally known in the context of network planning. Herein, intermediary time periods with positive duration (the end date of the intermediary time period is time wise behind its start date) are designated as “idle periods” in a descriptive manner. These have to be included into planning the time based sequence, when e.g. a product of a production step cannot immediately be processed further after the completion of said production step, since it has to dry or cool before. Intermediate time periods with negative duration (herein, the end date of the intermediate time period is time wise before its start date) are defined in network planning, in order to integrate a possible overlap into the planning, e.g. when a continuously generated product of a production step can already be processed further before its end date in a subsequent production step.

Since the duration of a production step in a non-bottleneck cost center is added in the context of time based scheduling to an intermediary time period associated as an idle time with the logical relationship between a preceding and a subsequent process step, the method according to the invention significantly simplifies the processing in the context of network analysis without neglecting data, which are relevant from a business point of view. If the projection step thus “blacked out” comprises several logically preceding and/or subsequent production steps, its duration is added to the intermediary time periods associated with all logical relationships between said production steps. Based on the known management information system, it is suggested according to the invention that non-bottleneck cost centers can be defined, for which the respective job order is a to-do list, thus does not include a set sequence for the production steps to be executed. The MIS according to the invention facilitates executing the method according to the invention described supra.

### EMBODIMENT

The invention is subsequently described with reference to the embodiment. It is shown in:

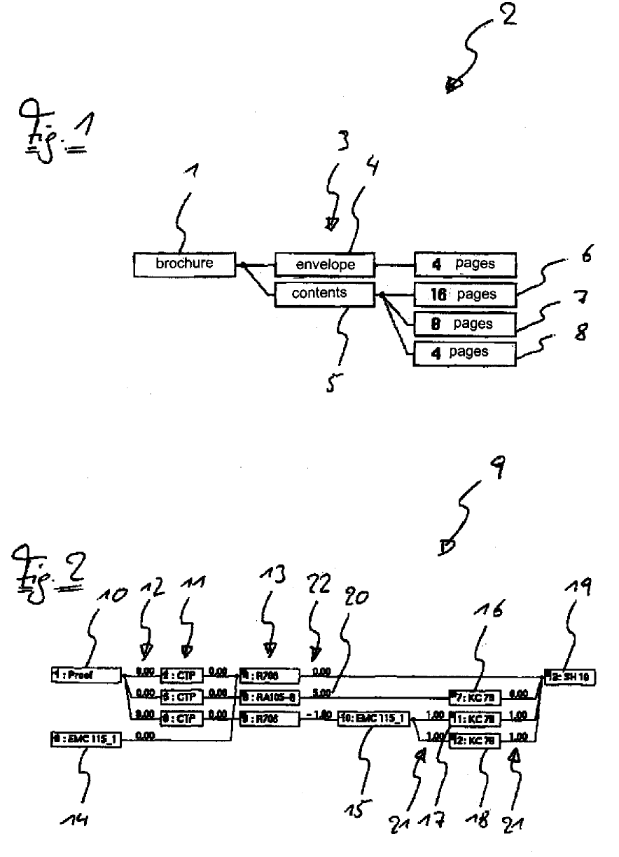

FIG. 1 a product tree diagram for a job; and

FIG. 2 a network diagram for said job.

A fictitious networked offset print shop manages by means of an MIS according to the invention among other things a prepress system, a platesetter, two print presses (with the internal designations “R706” and “RA105-8”), a cutting machine (“EMC 115_{—}1”), a folding machine (“KC 78”) and a gang stitching machine (“SH 10”), which communicate with the MIS through respective CIP compatible interfaces.

Among other things, the MIS comprises a scheduling module, in which among other things a job order to produce a print product 1 “brochure” in DIN A4 format is scheduled. According to the product tree diagram 2 of the print product 1, illustrated in FIG. 1 in a simplified symbolized manner, said print product comprises two product components 3, thus a 4-page wrapper 4 and a content 5 with 28 pages. The content 5 of the print product 1 is produced on three fold sheets 6, 7, 8 with 16 pages, 8 pages and 4 pages.

According to the process structure illustrated in a symbolically simplified manner in FIG. 2 according to the event node method in a network diagram 9 for print production of the print product 1, after signoff of the control printout by the customer, three production steps 11 “CTP” (“computer to plate”, platesetting) are started in the production step 10 “proof”. The intermediary times 12 between the production step 10 “proof” and the three production steps 11 “CTP” are set to “0,00”. Further logical dependencies do not exist. Thus all three plates can be exposed directly after the “proof”, if respective capacities are available.

After exposing the plates, these are directly available in three process steps 13 “print”. Since the wrapper 4 is to be printed as a 4-pager, but the base sheet in the heavy paper weight to be used is only in stock in a larger format, it has to be cut to size in advance in a production step 14 “cut”. The content of the print product 1 is printed onto print sheets, one with a 16-page fold sheet 6 and another one with the 8-pager and the 4-pager. The latter is divided in another process step 15 “cut” into the two fold sheets 7, 8 all three fold sheets 6, 7, 8 subsequently each go through one production step 16-18 “fold”, and are bound in a joint production step 19 “binding” together with the wrapper on the gang stitching machine into the print product 1 as an end product.

As an intermediary time 20 between printing and folding the 16-page fold sheet 6, a five hour idle time is scheduled for technical production reasons and as intermediary times 21 respectively before and after folding the two other fold sheets 7, 8 of the content 5, a respective 1 hour idle time is scheduled. A negative intermediary time 22 between printing and cutting of the print sheet combined from the 8-pager and the 16-pager, indicates that said print sheet can be handed over to cutting already one hour before the scheduled end date of the printing.

The cost centers “cutting machine” and “platesetter” are no bottleneck cost centers of said print shop after analyzing their historic utilization statistics. The cost center “proof” is thus as a matter of principle not scheduled from a capacity point of view in this context, since it does not tie up any capacities besides generating and sending the control printout up to the release by the external customer. In the scheduling module of the MIS, therefore, in order to compute the particular start and end dates for the production of the print product 1, only the cost centers “print machine”, “folding machine” and “gang stitching machine” are scheduled in a MPM algorithm. The durations scheduled for the production step “proof”, the production steps 14, 15 “cut” and the production steps 11 “CTP” are added after the printing to the intermediary times 12, 20-22, herein in particular added as preceding idle times to the production steps 13 “print” and to the production steps 17, 18 “fold” of the 8-pager and of the 4-pager.

During the production of the print product 1, the linked execution systems according to CIP4 continuously report their respective status, and in particular the beginning and the end of the execution of a production step 10, 11, 13-19 to the MIS. These reports of the execution systems are associated with the particular cost centers based on the structure, defined in the scheduling module.

After a feedback of the preprint system “proof released by customer”, the MIS schedules the production steps 11 “CTP” for the next available start dates of the cost center “plate exposure machine” and the production step 14 “cut” the base sheet for the wrapper 4 for the next available start date of the cost center “cutting machine”. Based on the end dates calculated there from and based on the subsequent intermediary times 10, 20-22, the MIS in turn schedules the print of the 16-pager with the content 5 for the next available beginning date of the cost center “print press RA105-8” and schedules the print of the wrapper 4 and of the print sheet with the 8-pager and of the 4-pager with the content 5 in the cost center “print press R706” and furthermore schedules the production step 15 “cutting” of said print sheet in the cost center “cutting machine” and schedules the production steps 16-18 “Tolding” in the cost center “folding machine” and schedules the final production step 19 “binding” in the cost center “gang stitching machine”.

Based on the additional feedback reports from the execution systems, the MIS continuously monitors the execution of the particular production steps 10, 11, 13-19, adapts the planning of the further execution as far as necessary and possibly reports a delay of critical dates, in particular of the end date, to the operator of the MIS.

### DESIGNATIONS

1 print product
2 product tree diagram
3 product component
4 wrapper
5 content
6 fold sheet “16-pager”
7 fold sheet “8-pager”
8 fold sheet “4-pager”
9 network diagram
10 production step “proof”
11 production steps “CTP”
12 intermediary times “proof—CTP”
13 production steps “print”
14 production step “cut”
15 production step “cut”
16 production step “fold”
17 production step “fold”
18 production step “fold”
19 production step “bind”
20 intermediary time “print—fold”
21 intermediary times
22 intermediary times “print—cut”

1. A method for scheduling and controlling jobs, wherein production steps (10, 11-19) of the jobs in cost centers with limited capacity are scheduled based on logical linking of the production steps (10, 11-19), which determines a time sequence of the execution of the production steps (10, 11-19), and based on the anticipated durations of executing the production steps (10, 11-19) are scheduled in the cost centers, wherein based on the scheduling, both an illustration of the sequence of execution of the production steps (10, 11-19) is generated for each job, and also a job order is generated for each cost center, which includes the respective production steps (10, 11-19) to be executed, wherein the job order for non bottleneck cost center is a to do list, thus no sequence is determined in the context of the scheduling for the production steps (10, 11-19) to be executed.

2. A method according to the preceding claim 1, wherein status reports with reference to the execution of the production steps (10, 11-19) are processed for controlling the production steps (10, 11-19) subsequently scheduled thereafter.

3. A method according to claim 1, claims, wherein the anticipated duration of the execution of a production step (10, 11-19) in a non-bottleneck cost center is planned in the context of scheduling as an intermediary time period (12, 20-22) between a logical predecessor of the production step (10, 11-19) and a logical successor of the production step (10, 11-19).

4. A management information system for scheduling and controlling jobs for producing print products in a networked graphic production, comprising a scheduling module, by means of which production steps (10, 11-19) of the jobs can be scheduled in cost centers with limited capacities, an illustration of a sequence of the execution of the production steps (10, 11-19) of the job can be generated for each job, and a job order comprising the production steps (10, 11-19) to be executed can be generated for each cost center, and wherein the management information system comprises a control module, by means of which the execution of the production steps (10, 11-19) can be controlled, wherein non-bottleneck cost centers can be defined, for which the respective job order is a to-do list, thus does not include a set sequence for the production steps (10, 11-19) to be executed.
